(19) United States
(12) Patent Application Publication
(10) Pub. No.: US 2007/0164089 A1
(43) Pub. Date: Jul. 19, 2007

(54) METHOD OF DISPENSING SMALL AMOUNTS OF LIQUID MATERIAL

(75) Inventor: Kevin W. Gaugler, Lincoln, RI (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/275,620

(22) Filed: Jan. 19, 2006

(51) Int. Cl. B23K 35/12; B23K 31/02; B23K 5/00

(52) U.S. Cl. 228/256; 228/260; 228/33

(57) ABSTRACT

A method of dispensing a solder paste comprising at least a flux carrier and solder onto a substrate, wherein the flux carrier and solder each have a melting temperature with the melting temperature of the solder being higher than the flux carrier, includes providing a reservoir of the solder paste and supplying the solder paste to a dispenser having an outlet through which the solder paste is dispensed. The solder paste is heated to a temperature of at least the melting temperature of the solder so that the flux carrier and solder are in a molten state. An amount of the solder paste is dispensed through the outlet and onto the substrate. The flux carrier and solder in the reservoir are maintained at a temperature below the melting temperature of the flux carrier so that neither of the flux carrier and solder is in a molten state in the reservoir.

### FIELD OF THE INVENTION

This invention generally relates to the field of dispensing liquid materials for a variety of purposes, and more particularly to a method of dispensing minute amounts of liquid materials in the assembly of electronic components and printed circuit boards.

### BACKGROUND OF THE INVENTION

In the manufacture of printed circuit (PC) boards, it is frequently necessary to apply small amounts of liquid materials. For example, it is often necessary to apply small amounts of liquid materials to form the various electrical connections associated with the manufacture of a PC board. In some applications, the electrical connections may be formed through a manual process such as hand soldering. In other applications, the electrical connections may be formed through a more automated process, such as a solder reflow process.

When forming an electrical connection using a solder process it is important that the surfaces that are to be electrically coupled via the solder are properly prepared to facilitate a strong connection between the surfaces. To this end, a solder flux is typically applied to the surfaces prior to the application of the solder. Solder flux is generally defined as a chemically and physically active formula which promotes wetting of a metal surface by molten solder, by removing the oxide or other surface films from the base metals and the solder. The flux also protects the surfaces from reoxidation during soldering and alters the surface tension of the molten solder and the base metal. Generally, fluxes commonly incorporate a solvent, a vehicle, an activator, a surfactant and an antioxidant. The solvent is the liquid carrier for the flux ingredient. The vehicle of the flux serves as a high temperature solvent during the subsequent soldering operation. The activator, on the other hand, removes contaminants such as oxides to present a wettable surface for the soldering operation. The surfactant encourages solder wetting while the antioxidant limits reoxidation of the surfaces.

In a traditional hand soldering process, flux is typically applied to the surfaces and heated to activate the flux and clean the surfaces. Next, a small amount of molten solder is applied to the surfaces typically using a soldering iron and a supply of solder wire. When the solder wire is positioned in proximity to the heated soldering iron, the terminal portion of the solder wire melts and is selectively deposited on the surfaces. Once the deposited solder is sufficiently removed from the soldering iron, the solder quickly cools and solidifies to form the electrical connection between the surfaces.

In more automated processes, such as high-density electronic manufacturing processes, microelectronic devices may be bonded to a PC board by a solder reflow process. For example, microelectronic devices including surface mountable packages, integrated circuit chips, etc., may be joinded to the PC board using such a process. Generally in the solder reflow process, solder bumps or balls are positioned on an array of metallic pads typically located on an underside of a microelectronic device. Application of the solder balls to the device is typically done in a separate processing step. Subsequent to placing the solder balls on the microelectronic device, the device is rotated or flipped over so that the solder balls register with a corresponding array of bond pads on the PC board. The entire electrical assembly, comprising the PC board and microelectronic device(s), is then heated. This heating in turn causes the solder in the solder balls to reflow so as to form electrical connections between the corresponding metal pads on the microelectronic device and PC board.

The solder balls may be positioned on the metallic pads of the microelectronic device using several different approaches. In one approach, for example, a small amount of solder paste may be deposited on each metallic pad of the device. Solder pastes are generally composed of powdered solder alloys dispersed in a relatively small volume of carrier. Although solder pastes may be composed of different components, they generally comprise solder powder of fine metallic particles; flux to promote wetting and cleaning of the metal; viscosity control agents to control the rheological properties which influence deposition; and solvents to aid in the flux activation. In essence, solder paste is a combination of a flux carrier and solder as single medium. A wide variety of solder pastes are commercially available, such as from EFD, Inc. of East Providence, R.I.

The solder paste may be deposited on the pads of the microelectronic device using various dispensing apparatus including syringe dispensers. Syringe dispensers are contact devices that rely on the dispensed liquid material simultaneously contacting the PC board and the syringe tip. The syringe dispenser is typically moved toward and away from the PC board during the dispensing process to separate or break the dispensed liquid from the dispenser. This movement causes stringing of the dispensed liquid, a build-up of liquid at the syringe tip and other undesirable results. More recently, manufacturers have moved away from contact dispensing devices in lieu of non-contact dispensers that shoot or jet the liquid material onto the PC board without any contact between the dispensing device and the board. For instance, one such dispensing device for jetting solder paste is disclosed in U.S. Pat. No. 6,267,266, assigned to the assignee of the present invention and hereby incorporated by reference herein in its entirety.

Once the solder paste is deposited onto the metallic pads of the microelectronic device, the device may be heated. The heat causes the flux in the solder paste to be activated thereby cleaning the surface and enhancing wettability. The heat further causes the solder in the solder paste to reflow to form the solder balls on the microelectronic device when the device is removed from the heat. With the solder balls formed on the metallic pads of the device, a traditional reflow process may be subsequently used to couple the microelectronic device to the PC board, as previously explained.

In another approach, solder balls may be deposited on the pads of a microelectronic device without using flux. In this approach, molten solder is jetted onto the metallic pads of the microelectronic device to form the solder balls. A high-energy pulsed laser may be used to clean the surface of the pads by ablating away any surface oxides and/or contaminants. To prevent reoxidation of the jetted droplets and cleaned surface, the deposition process is conducted in a closed chamber having a relatively inert atmosphere. For example, an inert gas may continuously flow through the chamber to not only prevent reoxidation of the droplet or surface, but also to carry the contaminants loosened by the laser away from the surface.

The above-described methods for forming electrical connections in the electronics industry have some disadvantages. For hand soldering applications, forming an electrical connection is a multi-step process requiring the application of flux and then the application of solder. Additionally, the application of solder is often a cumbersome and time consuming process requiring two hands, one to hold the soldering iron and the other to hold the supply of solder wire. Moreover, it is often difficult to accurately deposit a precise amount of solder in conventional hand soldering applications.

More automated systems used to, for example, form solder balls on microelectronic devices also have disadvantages. In the first approach described above, while the deposition of solder paste on the metallic pads eliminates the need to clean the surface with flux in a separate processing step, a heating step is introduced to simultaneously activate the flux and reflow the solder to form the solder balls. Heating the entire device to reflow the solder is time consuming, requires additional equipment and increases overall manufacturing costs. Moreover, the process of jetting molten solder as described above requires a controlled atmosphere, which in turn requires additional equipment and controls. Movement of the microelectronic device into and out of the chamber is also time consuming, labor intensive and not conducive to an automated manufacturing process.

Accordingly, there is a need for an improved method for dispensing small amounts of liquid material to form electrical connections on a PC board that addresses these and other drawbacks of current dispensing methods.

### SUMMARY OF THE INVENTION

An embodiment of the invention provides a method of dispensing solder paste comprising at least a flux carrier and solder onto a substrate. The flux carrier and solder each have a melting temperature with the melting temperature of the solder being higher than the melting temperature of the flux carrier. The inventive method includes providing a reservoir of the solder paste and supplying the solder paste to a dispenser having an outlet through which the solder paste is dispensed. For instance, the dispenser may be a hand-held type of dispenser or a dispensing module used in more automated processes. The method further includes heating the solder paste to a temperature of at least the melting temperature of the solder so that the flux carrier and solder of the solder paste are in a molten state. An amount of the solder paste is dispensed through the outlet and onto the substrate. The method further includes maintaining the flux carrier and solder of the solder paste in the reservoir at a temperature below the melting temperature of the flux carrier so that neither of the flux carrier and solder is in a molten state.

In another embodiment of the invention, a method of dispensing solder paste onto a substrate to facilitate the formation of an electrical connection is disclosed. The solder paste includes at least a flux carrier and solder, the flux carrier and solder each having a melting temperature with the melting temperature of the solder being higher than the melting temperature of the flux carrier. The inventive method includes providing a reservoir of solder paste and supplying the solder paste to a dispenser having an outlet through which the solder paste is dispensed. The method further includes dispensing an amount of the solder paste through the outlet so that the dispensed amount of the solder paste forms a liquid droplet, wherein the flux carrier forms a first region of the droplet and the solder forms a second region of the droplet prior to the droplet contacting the substrate.

In this embodiment, to achieve the separation of the flux carrier from the solder, the method may include heating the solder paste to a temperature of at least the melting temperature of the solder so that the flux carrier and solder are in a molten state prior to being dispensed. With the flux carrier and solder in a molten state, when the amount of solder paste is dispensed from the outlet of the dispenser, the components of the solder paste form concentric spheres with the flux carrier forming an outer spherical shell and the solder forming an inner spherical core. The method may further include maintaining the flux carrier and solder of the solder paste in the reservoir at a temperature below the melting temperature of the flux carrier so that neither of the flux carrier and solder is in a molten state. For example, an insulator may be positioned between the reservoir and a heater used for heating the solder paste to reduce the heat transfer therebetween.

These and other objects, advantages and features of the invention will become more readily apparent to those of ordinary skill in the art upon review of the following detailed description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective and partial cross-sectional view of a dispenser in accordance with one embodiment of the invention;

FIG. 2 illustrates a configuration of the liquid material when dispensed from the dispenser; and

FIG. 3 is a cross-sectional view of a dispenser in accordance with another embodiment of the invention.

### DETAILED DESCRIPTION

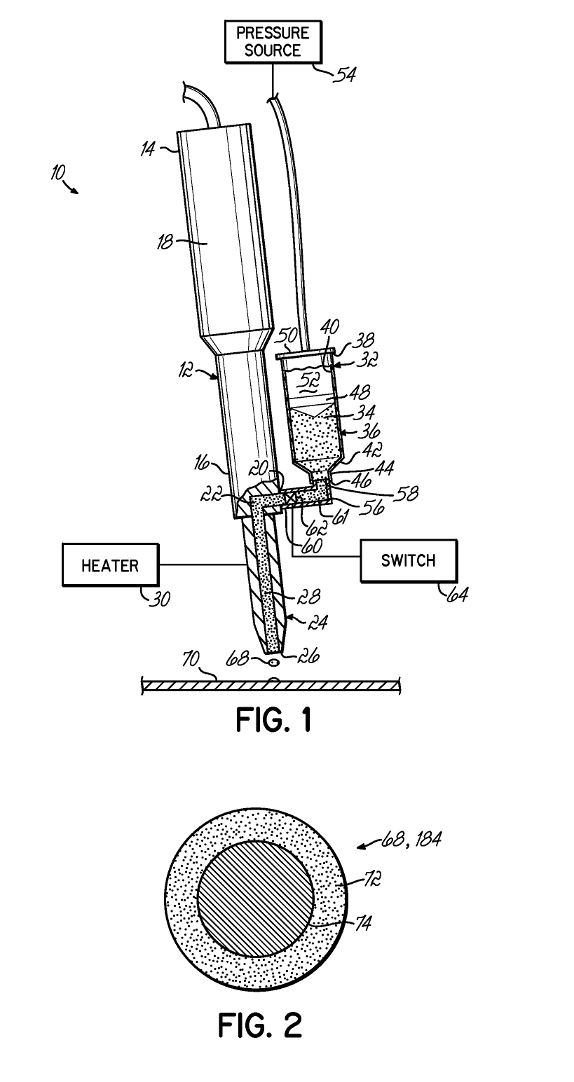

FIG. 1 and in one embodiment of the invention, an apparatus for dispensing a small amount of liquid material, such as solder paste, to form electrical connections between various electrical components in hand soldering applications includes an elongate member 12 having a proximal portion 14 and a distal portion 16. The proximal portion 14 defines a handle 18 adapted to be easily and conveniently grasped by a hand of an operator for manipulating the dispenser 10 during a dispensing process, as more fully described below. The distal portion 16 includes an inlet 20 and a first flow channel 22 in fluid communication with inlet 20.

A soldering tip 24 is coupled to the distal portion 16 of the elongate member 12 and includes an outlet 26 at the distal most end of the tip 24 in fluid communication with a second flow channel 28 extending through tip 24. When the tip 24 is coupled to elongate member 12, the second flow channel 28 is in fluid communication with the first flow channel 22. Dispenser 10 includes a heater shown schematically at 30, thermally coupled to tip 24. For example, heater 30 may be a resistance-type heater or any other suitable heater as is known in the art. Tip 24 may be formed from copper or other suitably high conductive materials that allow the tip 24 to be effectively heated by heater 30.

The apparatus further includes a reservoir, generally shown at 32, adjacent dispenser 10 for supplying liquid material 34 to dispenser 10. Throughout this application the term “liquid material” is intended to mean any substance that may be suitably received in and expelled by the dispenser, including but not limited to semisolid or highly filled materials having by volume or weight fifty percent (50%) or above solids, and low viscosity materials having by volume or weight below fifty percent (50%) solids. In one embodiment of the invention, the liquid material 34 is preferably a material having at least two components. The preferred embodiment is described herein with reference to dispensing small amounts of solder paste onto a PC board. Solder paste generally comprises a flux carrier as a first component and solder as a second component. The flux carrier primarily includes flux but may also include other substances, such as viscosity control agents, solvents, etc. The solder may include solder powder comprising fine metallic particles of one or more metals suitable for making solder, as is known in the art. Each component of the liquid material 34 has a melting temperature that results in the component being in a molten state when heated to at least its melting temperature. By way of example and not by limitation, the flux carrier of solder paste may have a first melting temperature and the solder have a second melting temperature. Typically, the melting temperature of solder is higher than the melting temperature of the flux carrier. Such solder pastes are commercially available from various suppliers, such as EFD, Inc. of East Providence, Rhode Island.

With reference to the drawings, reservoir 32 may be configured as a syringe 36 adapted to hold liquid material 34. Those of ordinary skill in the art will recognize that many different types of liquid material storage and delivery devices could be used in place of syringe 36. The syringe 36 includes a proximal end 38 defining an opening 40 for filling syringe 36 with liquid material 34, and a distal end 42 having a connecting member 44 with an outlet 46. A plunger 48 is positioned in syringe 36 above the liquid material 34 and an end cap 50 may be positioned on the proximal end 38 to close off the interior 52 of syringe 36. A pressure source 54, such as a pneumatic pressure source, may be in fluid communication with the interior 52 of syringe 36 for supplying a downward force to plunger 48 thereby causing liquid material 34 to be dispensed through outlet 46. As recognized by one of ordinary skill in the art, the applied pressure may be pulsed or may be constant, depending on the particular application and desires of the operator.

The apparatus further includes a conduit 56 having a first end 58 coupled to the connecting member 44 of syringe 36, a second end 60 coupled to the inlet 20 of the elongate member 12, and a flow path 61 in fluid communication with the first and second ends 58, 60. Conduit 56 is adapted to supply liquid material 34 from reservoir 32 to dispenser 10. In one aspect of the invention, conduit 56 may be made from a low thermal conductivity material so as to reduce the heat transfer from the tip 24 to the reservoir 32. In this way, the conduit 56 operates as an insulator effectively insulating the reservoir 32 from the heat generated by heater 30 and resulting in a lower temperature in the reservoir 32. For instance, conduit 54 may be made of a ceramic material or other composites that can withstand the temperatures and provide an insulative feature. The reasons for such an insulator are explained in more detail below. As used in this application, “insulator” is intended to mean any material having at least some structural aspect that forms at least a portion of the apparatus and has a relatively low thermal conductivity. Thus, for example, air that surrounds a dispenser would not be such an insulator. Those of ordinary skill in the art will recognize that while FIG. 1 shows a generally tubular conduit coupling the reservoir to the dispenser, in general any type of housing that permits fluid communication between the reservoir and dispenser may be used. Those of ordinary skill in the art will further recognize other ways to reduce the heat transfer to the reservoir, such as with a heat exchanger.

A valve 62 is disposed in conduit 56 and includes an opened and closed position. The dispenser 10 is adapted to dispense liquid material 34 from the outlet 26 of tip 24 when valve 62 is in the opened position. Additionally, the dispenser 10 is adapted to prevent liquid material 34 from being dispensed from outlet 26 when valve 62 is in the closed position. In this way, valve 62 effectively gives an operator control over the dispensing process. To actuate valve 62 between the opened and closed positions, the apparatus may further include a switch 64 operatively coupled thereto. For instance, switch 64 may include a finger or thumb switch positioned in handle 18. Alternatively, switch 64 may include a foot pedal for actuating valve 64. Those of ordinary skill in the art will recognize other types of switches that may be used with the invention. Those of ordinary skill in the art will also recognize that valve 64 may be positioned anywhere between the outlet 46 of syringe 36 and the outlet 26 of the tip 24. For instance, valve 64 may be positioned in the first flow channel 22 of elongate member 12.

In operation, the dispenser 10 is adapted to be grasped by the hand of an operator and moved to a location where an electrical connection is desired (not shown). The heater 30 is powered by connection to an electrical source. For instance, dispenser 10 may be plugged into an electrical outlet or alternately carry a battery that provides power to heater 30. Heater 30 heats the tip 24 to a temperature of at least the highest melting temperature of the components of liquid material 34. For solder paste, the heater 30 is adapted to heat tip 24 to a temperature of at least the melting temperature of the solder. To dispense a small amount of liquid material 34, an operator positions the outlet 26 of tip 24 adjacent to the desired electrical connection and actuates switch 64 so as to move valve 62 to an opened position. When valve 62 is in the opened position, the pressure source 54 applies a sufficient pressure to plunger 48 so as to force liquid material 34 through outlet 46, through conduit 56 and into dispenser 10 via inlet 20. The liquid material 34 travels through first flow channel 22, into the second flow channel 28 and through the outlet 26 in tip 24.

As a result of heating liquid material 34 to a temperature of at least the highest melting temperature of its components, each component of liquid material 34 is in or is brought to a molten state in the tip 24. Thus, heating the solder paste to a temperature of at least the melting temperature of solder brings both the flux carrier and solder into a molten state. The pressure source 54 further causes an amount of liquid material 34 to be dispensed through the outlet 26 of tip 24. In a preferred embodiment of the invention, the liquid material 34 is dispensed from the dispenser 10 in a non-contact manner. In an important aspect of the invention and as shown in FIG. 2, the liquid material 34 dispensed from dispenser 10 forms a generally spherical liquid droplet 68 prior to contacting a substrate 70 where an electrical connection is desired. Advantageously, when the liquid material 34 is dispensed, the components of the liquid material 34 in the droplet 68 separate into distinct regions. Thus, the first component forms a first region of droplet 68 and the second component forms a second region of droplet 68. In embodiments of the invention, because the components of liquid material 34 are each in a molten state, surface tension effects cause the components to separate into distinct regions when dispensed. For instance, as shown in FIG. 2 for solder paste, the molten flux carrier forms an outer spherical shell 72 around an inner spherical core 74 of molten solder. The surface tension of solder is greater than that of the flux carrier and thus forms the inner core 74.

As noted above, the dispensed amount of the liquid material 34 includes each component of liquid material 34. Thus for solder paste, the dispensed amount includes both flux carrier and solder. To ensure that the dispensed amount includes each component, it is important that liquid material 34 does not become prematurely separated such that, for example, only one component is dispensed. To this end, it is important that the liquid material 34 does not become separated in reservoir 32. If the components would become separated in reservoir 32, the heavier component would migrate or collect at the bottom of syringe 36 near outlet 46. Then when dispenser 10 is actuated, such as by opening valve 64, only the heavier component would be initially supplied to dispenser 10. Thus, it is important that the reservoir 32 remains thermally isolated from the heater 30 and the heated portions of dispenser 10, such as tip 24, to prevent premature separation. To this end, the liquid material 34 in reservoir 32 is maintained below the melting temperature of each of the components so that no component is in the molten state in reservoir 32. As applied to solder paste, the reservoir 32 is maintained below the melting temperature of the flux carrier to prevent separation within reservoir 32. As described above, conduit 56 operates as an insulator to reduce the heat transfer between the heater 30 and/or the heated portions of dispenser 10 and reservoir 32. As recognized by those of ordinary skill in the art, other insulative components may be added to dispenser 10 to reduce the temperature of the liquid material 34 within reservoir 32.

The separated configuration shown in FIG. 2 provides certain advantages for forming electrical connections using solder paste. For instance, because the flux carrier forms the outer shell 72, the flux carrier contacts the substrate 70 prior to the spherical core 74 of molten solder. In this way, the flux carrier sufficiently cleans and prepares the substrate 70 such that the solder wets the substrate 70 and facilitates the formation of a good bond for an electrical connection. Moreover, the separated configuration of the solder paste shown in FIG. 2 combines two processing steps into a single process, i.e., the application of flux and the application of solder are performed in a single processing step. The apparatus of FIG. 1 also provides advantages for hand soldering applications. In particular, only a single hand is required to operate or manipulate the dispenser 10 in order to form electrical connections. This, of course, frees one hand to perform other activities associated with forming an electrical connection.

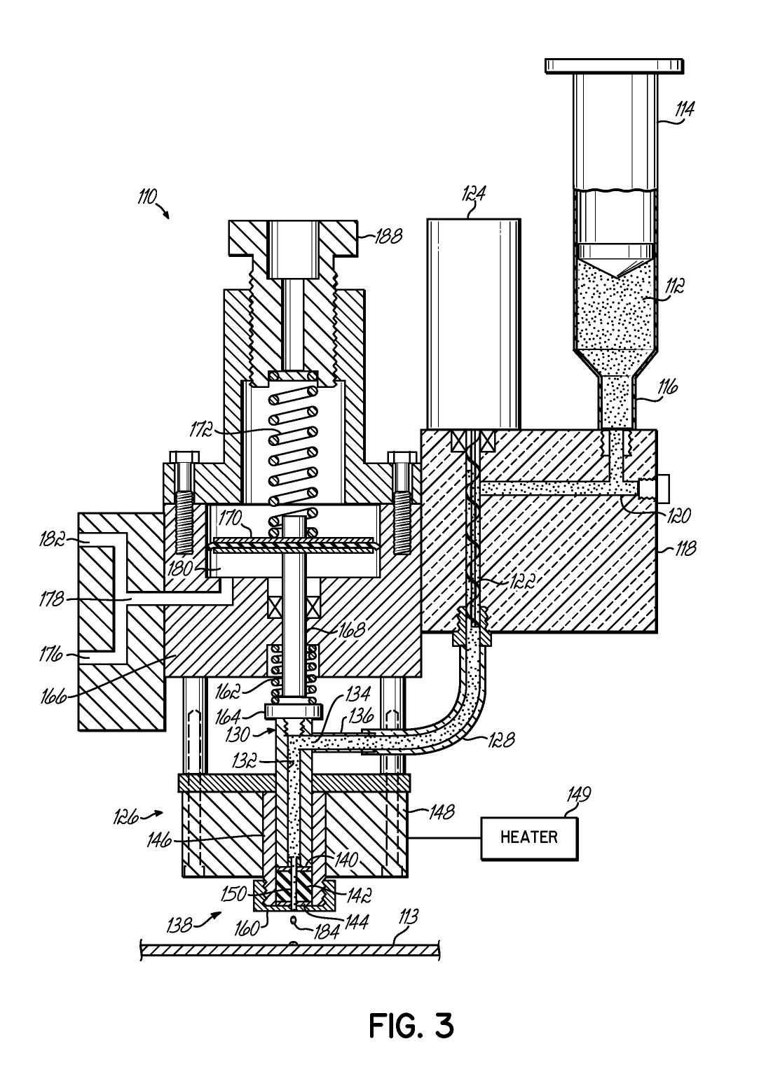

The invention is not limited to hand soldering applications but may also be applied to other applications, such as automated processes for forming solder balls on the metallic pads of microelectronic devices. With reference to FIG. 3 and in another embodiment of the invention, a dispenser 110 for dispensing a small amount of liquid material 112 onto a substrate 113 includes a reservoir, such as a syringe 114 for supplying, under pressure, the liquid material 112 to be dispensed. As recognized by those of ordinary skill in the art, any type of liquid material storage and delivery device could be used in place of syringe 114. The syringe outlet portion 116 is threadedly received in a mixer block 118, and is in fluid communication with a flow channel 120 formed in the mixer block 118.

In an embodiment, a mixer 122 is disposed in a vertical portion of the flow channel 120. The mixer 122 may be a spiral-type having nylon bristles about its outer surface, but it should be understood that many other types of mixers, both static and dynamic, that are capable of maintaining the proper consistency of the liquid material may be used without departing from the scope of the invention. The mixer 122 is coupled to the mixer drive 124 for rotating the auger within the flow channel 120. It should be understood that the mixer 122 and associated components may be omitted if the material 112 does not have to be mixed to maintain the proper consistency or viscosity, in which case the syringe 114 is coupled directly to a lower housing 126.

In an embodiment the mixer block 118 is connected to the lower housing 126 by a conduit 128, and the conduit 128 is in fluid communication with a piston 130 having a flow or central bore 132 formed therein. The piston 130 is positioned within the lower housing 126 and liquid material 112 enters the piston 130 at an inlet 134 of the flow bore 132, and a generally rigid conduit 136 is used to couple the conduit 128 to the inlet 134.

A bellows valve assembly 138 comprises an upper or pressure plate 140, a resilient and compressible core element 142 and a nozzle 144. In an embodiment the core element 142 is generally cylindrical in shape, however, other geometric configurations may be used as required. The bellows valve assembly 138 is positioned below the piston 130 and partially within the lower housing 126 with the nozzle 144 extending beyond the lower housing 126. A sleeve 146 forms a portion of the lower housing 126. The piston 130 and a portion of the bellows valve assembly 138 are closely received in the sleeve 146.

A heating block 148 is positioned around the sleeve 146 and a heater, shown schematically at 149, is thermally coupled to the heating block 148 to heat at least part of the lower housing 126 such that the liquid material 112 in the flow bore 132 and/or bellows valve assembly 138 is properly heated. For example, heater 149 may be a resistance-type heater or any other suitable heater as is known in the art. The heating block 148 is preferably formed of a heat conducting material, such as aluminum.

The bellows valve assembly 138 has a central flow passage or bore 150 formed therein, the passage 150 having a receiving inlet and a discharge outlet and a central portion connecting the receiving inlet and discharge outlet. The outlet of the piston flow bore 132 is in fluid communication with the inlet of bellows valve assembly 138. The upper or backing plate 140, resilient and compressible core element 142 and nozzle 144 are adhered by any process such as a vulcanized metal to rubber process well known in the field, and the integral bellows valve assembly 138 is held in place by a nut 160 threadedly attached to the sleeve 146. Other arrangements, such as forming extensions in the bellows valve assembly 138 that are received by cut-outs in the piston 130 or nozzle 144, for example, may be used to couple the bellows valve assembly 138 to the piston 130 and will be readily apparent to those skilled in the art.

In operation, the passage 150 receives the material 112. The core element 142 is formed from any resilient or compressible material, such as an elastomer, neoprene, urethane, rubber, or polyisoprene. As noted above, the piston 130 is positioned above the bellows valve assembly 138, and in the preferred embodiment remains in contact with the upper plate 140. The piston 130 applies a generally uniform axial force to the top surface of the upper plate 140. A compression spring 162 is located between a force receiving element, or anvil, 164 and the block 166. This spring maintains the piston 130 lower end in contact with the upper plate 140 during operation of the dispenser 110.

Upon the application of a downward force generally along the direction of passage 150 on the upper plate 140 via a hammer shaft 168 and the anvil 164, the core element 142 is axially compressed. The outer surface or wall of the core element 142 is constrained by and pressed against the sleeve 146, forcing the walls of the passage 150 to converge and close the passage 150, thereby blocking the flow of material 112 into the passage 150 and forcing at least some of the liquid material 112 within the passage 150 out of the outlet of nozzle 144. The piston 130, through force applied by a piston spring 172 to the hammer shaft 168 via an actuator piston 170, is biased to apply a force to the bellows valve assembly 138 that is sufficient to maintain the bellows valve assembly 138 in the closed position. The outer surface of the bellows valve assembly 138 is constrained by the sleeve 146 from significant expansion in a direction generally perpendicular to the force applied by the piston 130. The nozzle 144 opposes the force applied by the piston 130 to limit the compression of the core element 142 in the direction of the applied force.

When the bellows valve assembly 138 is in the closed position, the actuator piston 170 is in its lower position (not shown). The piston spring 172 applies a force to the actuator piston 170, and the hammer shaft 168 is rigidly attached to the piston 170. The hammer shaft 168 is thereby urged into contact with the anvil 164 that is threadedly received in the piston 130. The force applied by the hammer shaft 168 and transmitted by the piston 130 to the upper plate 140 keeps the bellows valve assembly 138 in the closed position in the absence of actuation pressure applied to the piston 170. The piston 130 preferably applies a generally uniform force across the top surface of the upper plate 140.

When it is desired to dispense a droplet of liquid material 112, air is routed through an inlet air path 176, through a common path 178 in the block 166, and into a lower air chamber 180. The air pressure in the lower air chamber 180 overcomes the force of the piston spring 172, and moves the air piston 170 upwardly. The shaft 168 is thus lifted off of the anvil 164, thereby removing the axial compressive force applied on the bellows valve assembly 138. As this force is removed, the bellows valve assembly 138 returns to its uncompressed shape and the walls of the passage 150 diverge, which opens the passage 150 into which the material 112 flows. Once the dispenser 110 is in the open position, the material 112 enters the passage 150 of the bellows valve assembly 138. The force is removed from the upper plate 140 for a predetermined amount of time to allow a predetermined amount of material 112 to enter the inlet of the passage 150. Once sufficient time has passed and it is desired to dispense the material 112, the flow of compressed air to the inlet air path 176 is terminated. This causes the piston spring 172 to urge the air piston 170 and shaft 168 downward into contact with the anvil 164. During the downward stroke, air is exhausted through the common path 178 and an exhaust path 182. The force of the compression spring 172 is once again transmitted to the piston 130 and bellows valve assembly 138, thereby causing the walls of the passage 150 to converge. As shown in FIG. 3, a threaded cap 188 may be used to vary the force applied by the actuator piston spring 172.

As the walls of the passage 150 converge, liquid material 112 that is contained in the passage 150 is urged out of the bellows valve assembly 138. Part of the liquid material 112 in the passage 150 is expelled upwardly back into the flow bore 132, and the remaining liquid material is expelled downwardly through the outlet of nozzle 144. Additionally, in a preferred embodiment, the walls of the passage 150 remain generally parallel as they converge. In this manner, the passage 150 maintains a generally uniform width as the walls of the passage converge in response to the application of an axial force.

As the walls of the passage 150 converge, a droplet 184 of liquid material 112 is formed and ejected or jetted from the outlet of nozzle 144. The convergence of the passage walls is preferably fast enough to form a droplet 184 which separates from the dispenser 110, thereby expelling the droplet 184 from the dispenser 110. This jetting action avoids having the nozzle 144 make contact with the substrate 113 upon which the liquid material 112 is to be dispensed. Furthermore, the dispensed droplet 184 does not make contact with the substrate 113 and the nozzle 144 at the same time, thereby providing a clean non-contact dispensing operation.

In an advantageous aspect of the invention, heater 149 heats the liquid material 112 in at least a portion of the lower housing 126 to a temperature of at least the highest melting temperature of the components of liquid material 112. For solder paste, the heater 149 is adapted to heat the liquid material 112 to a temperature of at least the melting temperature of the solder. As a result of the heating, each component of liquid material 112 is in or brought to a molten state in lower housing 126. For solder paste, both the flux carrier and the solder are in a molten state in at least a portion of lower housing 126.

The liquid material 112 dispensed from dispenser 110 forms a generally spherical droplet 184 prior to contacting the substrate 113. The droplet 184 includes each component of liquid material 112 and the components separate into distinct regions, such as generally concentric spheres as shown in FIG. 2. As in the previous embodiment, for solder paste the molten flux carrier forms an outer spherical shell 72 around an inner spherical core 74 of molten solder. Moreover, as in the previous embodiment, it is important that the liquid material 112 does not separate while in the syringe 114. To this end, the conduit 128 may be made of a low thermal conductivity material, such as a ceramic material or other composite, and effectively operate as an insulator between the heater 139 or heated portions of dispenser 110 and the syringe 114. The mixer block 118 may also be made from an insulating material to reduce the heat transfer between the heater 149 and syringe 114. Alternately, an insulating material may be positioned between block 166 and mixer block 118.

Dispenser 110 may advantageously be used to form solder balls on the pads of microelectronic devices that overcomes at least some of the disadvantages of the previous methods. For instance, using the dispenser 110 to form solder balls eliminates the heating step used to activate the flux and reflow the solder when non-molten solder paste is dispensed and deposited on the microelectronic device. Additionally, using dispenser 110 also eliminates the closed chamber used in prior methods of applying solder balls to microelectronic devices.

While the embodiment of dispenser 110 shown and described herein uses bellows valve assembly 138 to open and close dispenser 110, the invention is not so limited as those of ordinary skill in the art will recognize that the invention may be utilized in other types of jetting dispensers. For instance, instead of bellows valve assembly 138, a needle valve or solenoid valve may be utilized to open and close a dispenser. By way of example and not by limitation, such alternate valve assemblies used to open and close a dispenser are shown in U.S. Pat. Nos. 5,747,102 and 6,253,957, the disclosures of which are incorporated by reference herein in their entirety.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. A method of dispensing a solder paste comprising at least a flux carrier and solder onto a substrate, the flux carrier and solder each having a melting temperature with the melting temperature of the solder being higher than the melting temperature of the flux carrier, the method comprising:
providing a reservoir of the solder paste;
supplying the solder paste to a dispenser having an outlet through which the solder paste is dispensed;
heating the solder paste to a temperature of at least the melting temperature of the solder so that the flux carrier and solder are in a molten state;
dispensing an amount of the solder paste through the outlet and onto the substrate; and
maintaining the flux carrier and solder of the solder paste in the reservoir at a temperature below the melting temperature of the flux carrier so that neither of the flux carrier and solder is in a molten state.

2. The method of claim 1, wherein heating the solder paste further comprises:
heating the solder paste in the dispenser and adjacent the outlet.

3. The method of claim 1, wherein dispensing the solder paste onto the substrate further comprises:
jetting the solder paste onto the substrate.

4. The method of claim 1, wherein dispensing the solder paste further comprises:
dispensing the solder paste to form a liquid droplet, wherein the flux carrier forms into a first region of the droplet and the solder forms into a second region of the droplet prior to the droplet contacting the substrate.

5. The method of claim 4, wherein the flux carrier and solder form into generally concentric spheres prior to the droplet contacting the substrate.

6. The method of claim 4, wherein the flux carrier forms into an outer spherical shell and the solder forms into an inner spherical core.

7. The method of claim 1, wherein maintaining the flux carrier and solder of the solder paste in the reservoir at a temperature below the melting point of the flux carrier further comprises:
positioning an insulator between the reservoir and a heater used for heating the solder paste.

8. A method of dispensing a solder paste comprising at least a flux carrier and solder onto a substrate, the flux carrier and solder each having a melting temperature with the melting temperature of the solder being higher than the melting temperature of the flux carrier, the method comprising:
providing a reservoir of the solder paste;
supplying the solder paste to a dispenser having an outlet through which solder paste is dispensed; and
dispensing an amount of the solder paste through the outlet so that the dispensed amount of the solder paste forms a liquid droplet, wherein the flux carrier forms a first region of the droplet and the solder forms a second region of the droplet prior to the droplet contacting the substrate.

9. The method of claim 8, wherein the flux carrier and solder form generally concentric spheres prior to the droplet contacting the substrate.

10. The method of claim 9, wherein the flux carrier forms an outer spherical shell and the solder forms an inner spherical core.

11. The method of claim 8 further comprising:
heating the solder paste to a temperature of at least the melting temperature of the solder so that the flux carrier and the solder are in a molten state prior to being dispensed.

12. The method of claim 11 further comprising:
maintaining the flux carrier and solder of the solder paste in the reservoir at a temperature below the melting temperature of the flux carrier so that neither of the flux carrier and solder is in a molten state.

13. The method of claim 12, wherein maintaining the flux carrier and solder in the reservoir at a temperature below the melting temperature of the flux carrier further comprises:
positioning an insulator between the reservoir and a heater used for heating the solder paste.

14. The method of claim 8, wherein dispensing the solder paste onto the substrate further comprises:
jetting the solder paste onto the substrate.
